(19) United States
(12) Patent Application Publication
(10) Pub. No.: US 2013/0204977 A1
(43) Pub. Date: Aug. 8, 2013

(54) Systems and Methods for Panoramic Video Streaming of Virtual Tours

(71) Applicant: TourWrist, Inc., San Francisco, CA (US)

(72) Inventor: Charles Robert Armstrong, San Francisco, CA (US)

(73) Assignee: TOURWRIST, INC., San Francisco, CA (US)

(21) Appl. No.: 13/748,482

(22) Filed: Jan. 23, 2013

Related U.S. Application Data
(60) Provisional application No. 61/590,682, filed on Jan. 25, 2012.

(51) Int. Cl. H04L 29/06

(52) U.S. Cl. CPC H04L 65/60
USPC 709/219

(57) ABSTRACT

A virtual tour host server decomposes a virtual tour into a plurality of video faces which are stored. When a user desires to begin a virtual tour using a mobile device, the mobile device detects and reports a field of view to the host server. The host server then associates a subset of the plurality of video faces corresponding to the detected field of view, and sends a video stream of the virtual tour recomposed from the subset of video faces, enabling the mobile device to display the virtual tour video stream.

### CROSS REFERENCE TO RELATED APPLICATION

This non-provisional application claims the benefit of provisional application No. 61/590,682 filed on Jan. 25, 2012, entitled “Systems and Methods for Panoramic Video Streaming of Virtual Tours”, which application is incorporated herein in its entirety by this reference.

### BACKGROUND

The present invention relates to systems and methods for streaming of virtual tours. More particularly, the present invention relates to efficient streaming of panoramic virtual tours from a host to a mobile device.

Conventionally, panoramic video is converted to a series of, for example, six cube-face video files which can be displayed as adjacent surfaces within a virtual cube. Users typically select their viewing angle within this cubic environment, thus determining which of the cube-face video files are displayed within their field of view. Given that real-time panoramic video requires any portion of these six cube-faces be available (including that which is not currently being viewed), conventional methods of panoramic video streaming typically require inefficiently high amounts of data be streamed and buffered so that it can be delivered upon request.

It is therefore apparent that an urgent need exists for highly efficient systems and methods of streaming panoramic video which fulfills viewer expectations for real-time applications such as virtual tours.

### SUMMARY

To achieve the foregoing and in accordance with the present invention, systems and methods for streaming virtual tours are provided. In particular, the systems and methods efficiently stream panoramic virtual tours from a host server to a mobile device.

In one embodiment, a host server decomposes a virtual tour into a plurality of video faces which are stored in the host server. When a user desires to begin a virtual tour using a mobile device, a virtual tour viewer is launched on the mobile device.

The mobile device detects the user's field of view on the mobile device and reports the field of view to the virtual tour host server. The host server then associates a subset of the plurality of video faces which corresponds to the detected field of view of the mobile device, and sends a video stream of the virtual tour recomposed from the subset of the plurality of video faces. The mobile device then seamlessly displays the video stream using the virtual tour viewer executing in the mobile device.

In some embodiments, the mobile device also sends the user's navigational intentions to the host server, enabling the host server to anticipate the next video face likely to be needed by the mobile device. This additional video face can then be streamed to and buffered by the mobile device.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a perspective view of a mobile device capable of determining motion change(s) of the mobile device caused by a user for navigating virtual tours in accordance with one embodiment of the present invention;

FIGS. 2A and 2B illustrate six quadrilateral video faces of a cubic panoramic video environment for the embodiment of FIG. 1;

FIGS. 3A and 3B illustrate exemplary multi quadrilateral video faces of a cylindrical panoramic video environment for the embodiment of FIG. 1;

FIGS. 4A and 4B illustrate exemplary multi-faceted polygonal video faces of a spherical panoramic video environment for the embodiment of FIG. 1; and

FIG. 5 is a flow diagram illustrating the decomposition, recomposition and streaming of panoramic videos for the embodiment of FIG. 1.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to systems and methods for efficiently decomposing, storing, recomposing and streaming of panoramic videos for virtual tours (“VT”) executing on mobile devices. Note that the term “mobile device” is intended to include all portable electronic devices including cellular phones, computerized tablets, cameras, and hand-held gaming devices.

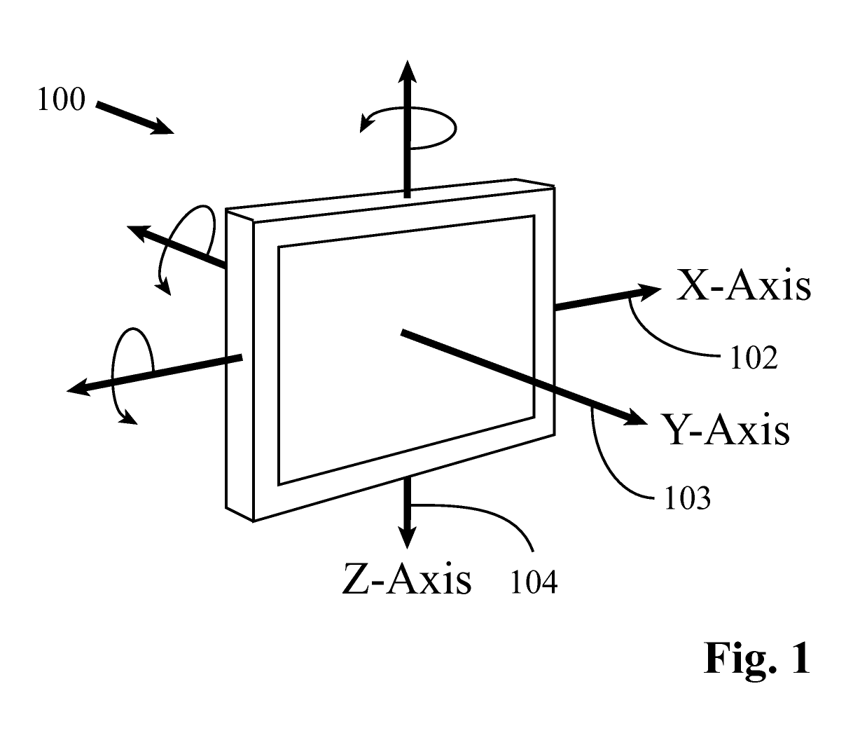

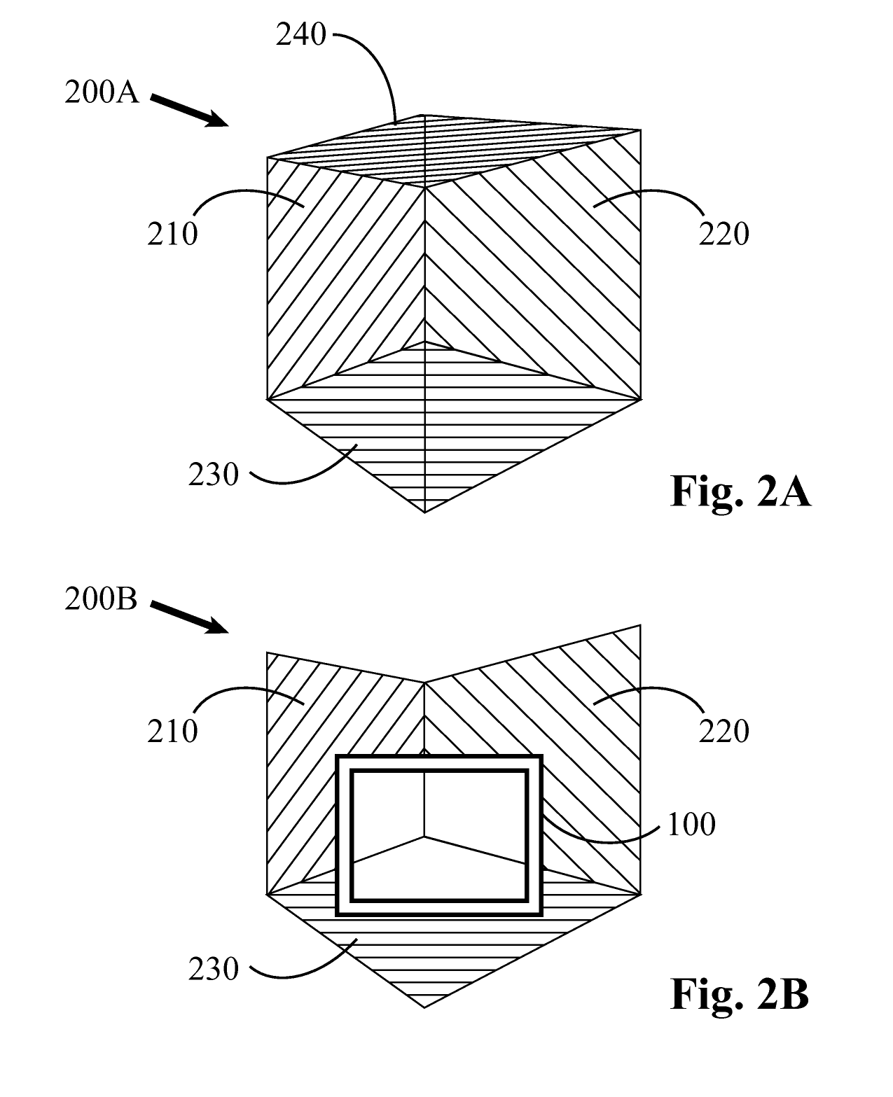

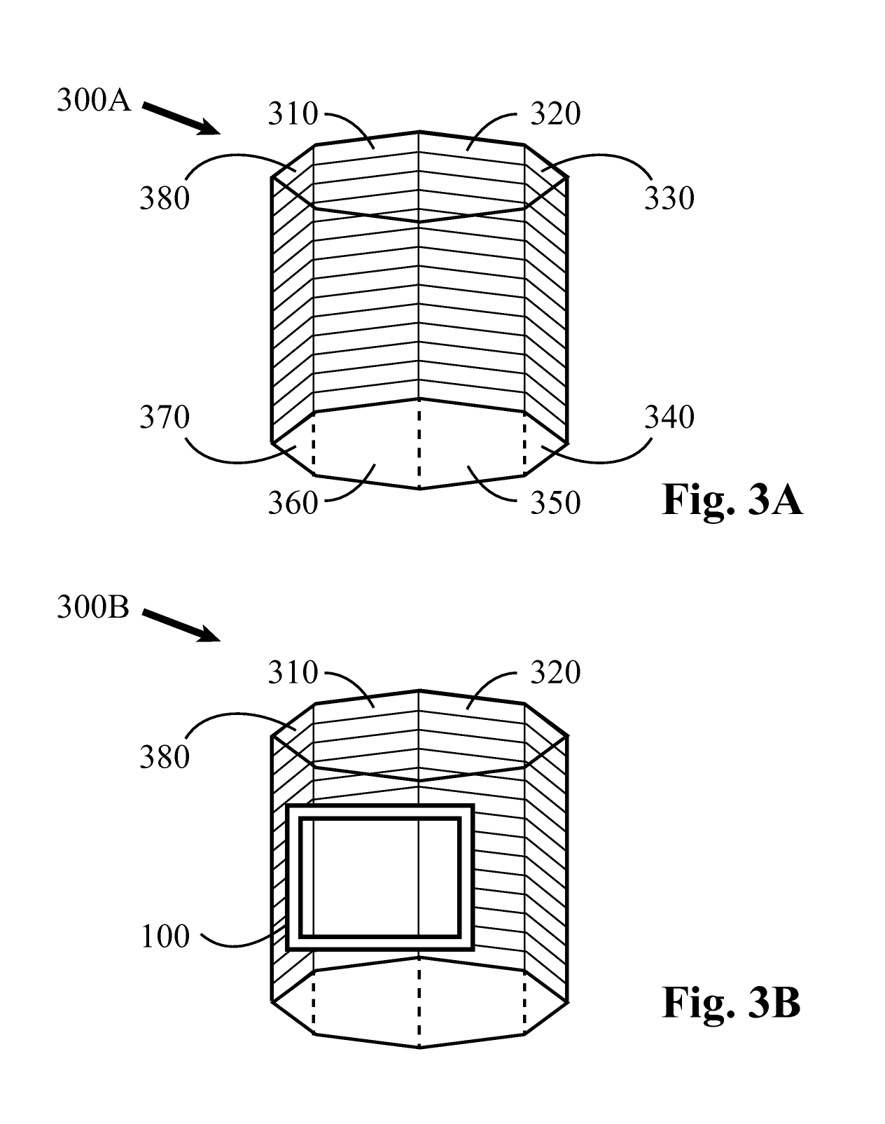

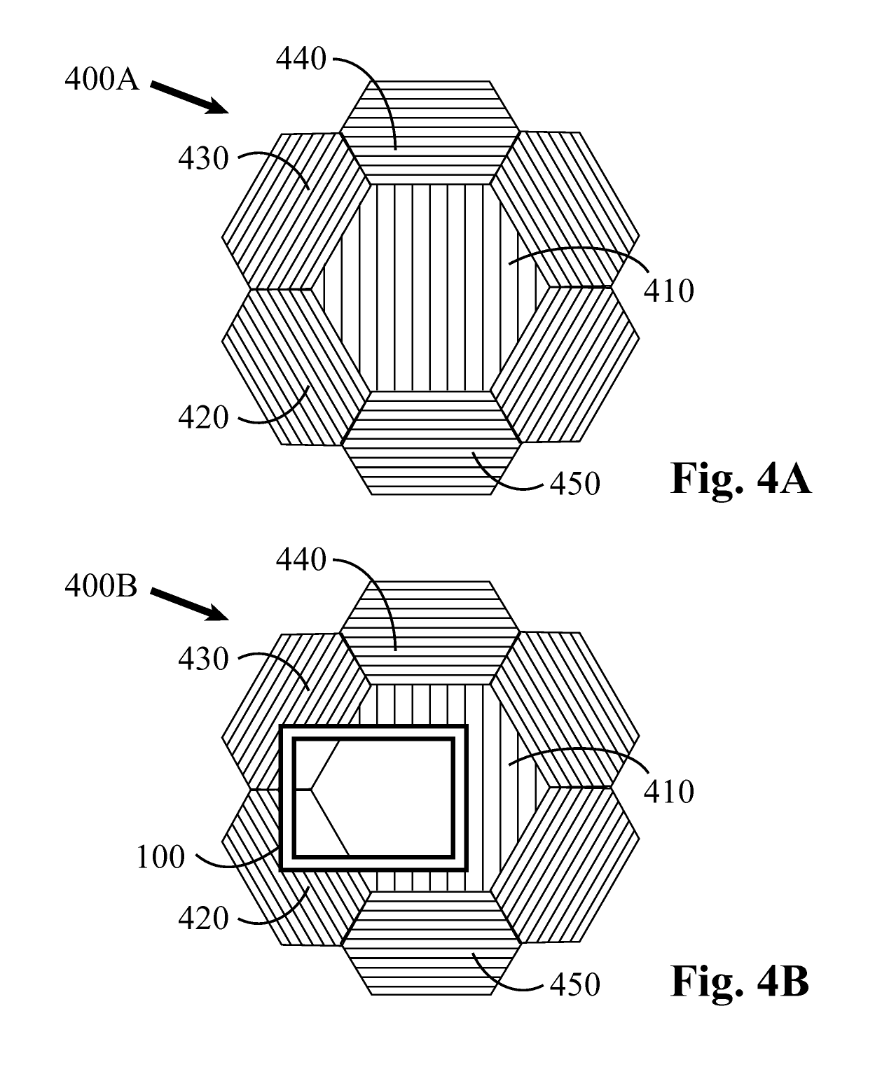

To facilitate discussion, FIG. 1 illustrates an exemplary mobile device capable of determining motion change(s) of the mobile device 100 caused by a user for navigating virtual tours in accordance with one embodiment of the present invention. FIGS. 2A and 2B illustrate a six-sided cubic panoramic video environment for mobile device 100. FIGS. 3A and 3B illustrate another exemplary multi-sided cylindrical panoramic video environment for mobile device 100, while FIGS. 4A and 4B illustrate yet another exemplary multi-faceted spherical panoramic video environment for mobile device 100.

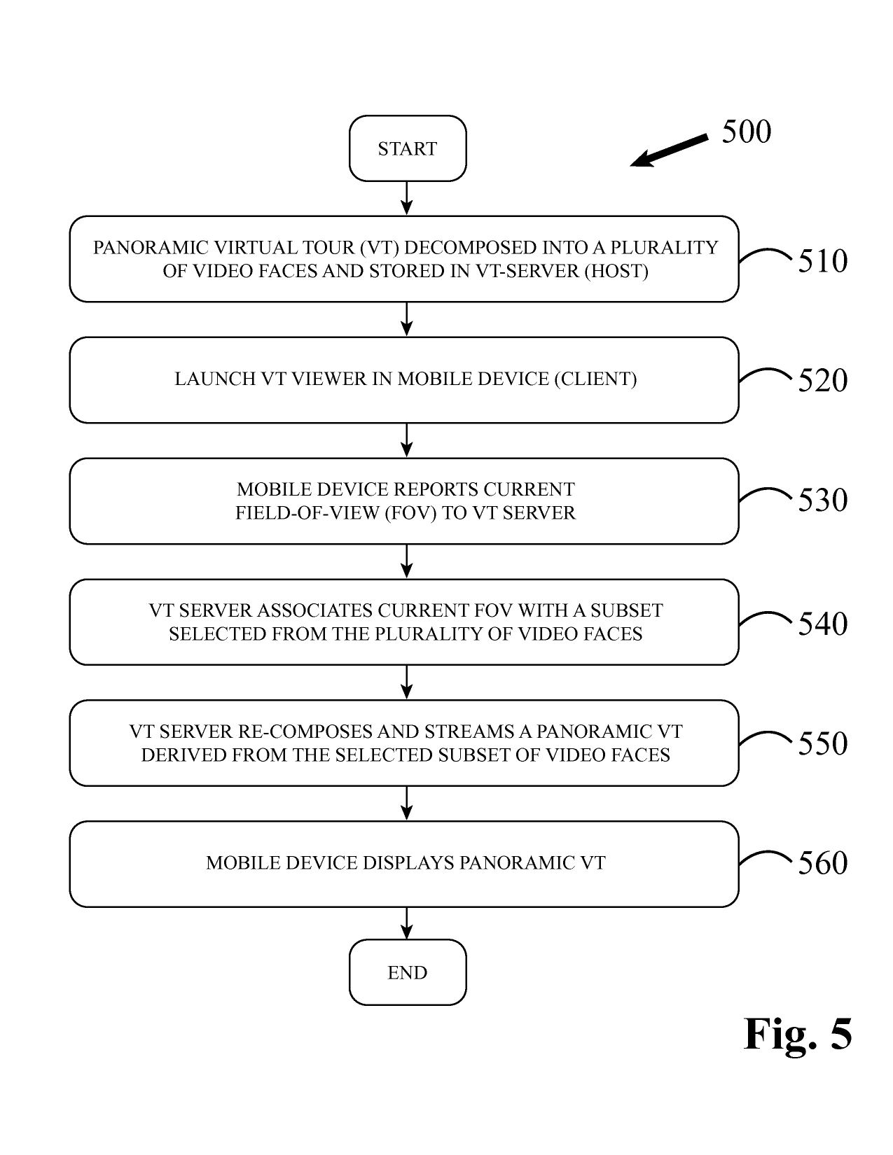

As illustrated by FIGS. 2A, 2B and the exemplary flow diagram of FIG. 5, in step 510, the panoramic VT is decomposed into six quadrilateral video faces of a cubic panoramic video environment, e.g., video-faces 210, 220, 230, 240, and stored in a VT host server (not shown). These six video faces are now available to be streamed on-demand from the host server to a mobile device 100 via, for example, a wide area network such as the Internet.

When a user, e.g., a VT visitor, desires to commence a virtual tour, a VT viewer is launched on mobile device 100 (step 520). In order to provide a realistic real-time viewing experience for the visitor of the virtual tour, mobile device 100 provides the current field-of-view (FOV) to the VT server (step 530).

In this embodiment, as shown in FIG. 2B, the FOV of mobile device 100 can include up to three of the six video faces, e.g., video faces 210, 220, 230. Accordingly, the VT server associates the FOV with a corresponding subset of video face(s) comprising up to three of the required video faces (step 540). This cubic video environment is well-suited for VTs of “surround-locations” such as amusement park rides, scuba diving spots and action movie sets. The VT server re-composed a panoramic VT derived from this selected subset of up to three video face(s) and efficiently streams the VT to the mobile device 100 for display (steps 550, 560).

Similarly, as exemplified by FIGS. 3A, 3B and the flow diagram by FIG. 5, in step 510, the panoramic VT is decomposed into multiple quadrilateral video-faces of a cylindrical panoramic video environment, e.g., eight video faces 310, 320, 330, 340, 350, 360, 370, 380, and stored in a VT host server (not shown). These eight video faces are now available to be streamed on-demand from the host server to mobile device 100.

The VT visitor commences a virtual tour by launching a VT viewer on mobile device 100 and provides the current field-of-view (FOV) to the VT server (steps 520, 530). As shown in FIG. 3B, the FOV of mobile device 100 can include up to three of the eight video faces, e.g., faces 380, 310, 320. Accordingly, the VT server associates the FOV with a current subset of video face(s) comprising up to three of the required video-faces (step 540). The VT server re-composed a panoramic VT derived from this selected subset of up to three video face(s) and efficiently streams the VT to the mobile device 100 for display (steps 550, 560).

Referring now to FIGS. 4A, 4B and the flow diagram by FIG. 5, in step 510, the panoramic VT is decomposed into multiple polygonal video faces of a multi-faceted spherical panoramic video environment, e.g., hexagonal video faces 410, 420, 430, 440, 450, and stored in a VT host server (not shown). In this example, video-faces 410, 420 . . . 450 are similar to the polygonal, e.g., hexagonal and/or pentagonal, leather panels for constructing a soccer ball or volleyball. This spherical video environment is also suited for VTs of “surround-locations” such as amusement park rides, scuba diving spots and action movie sets. These video faces are now available to be streamed on-demand from the host server to mobile device 100.

The VT visitor commences a virtual tour by launching a VT viewer on mobile device 100 and provides the current field-of-view (FOV) to the VT server (steps 520, 530). As exemplified by FIG. 4B, the FOV of mobile device 100 includes the three video faces 410, 420, 430. Accordingly, the VT server associates the FOV with a current subset of video face(s) comprising up to three of the required video faces (step 540). The VT server re-composed a panoramic VT derived from this selected subset of up to three video face(s) and efficiently streams the VT to the mobile device 100 for display (steps 550, 560).

It is contemplated that the VT viewer of the mobile device 100 may be capable of zooming in and out thereby contracting and expanding the field-of-view experienced by the VT visitor. Accordingly, depending on the zoom level selected, the field-of-view may include up to “N” video faces, wherein “N” can be any integer from one and up to the total number of video faces minus one; provided the total number of video faces is equal to or greater than four.

Many modifications and additions to the embodiments of the present invention are also possible. For example, mobile device 100 may also provide the user's VT navigational intentions to the VT server, enabling the VT server to anticipate which video face(s) may be needed soon, and thus enabling the VT server to begin streaming one or more additional video-face(s) to be buffered by the mobile device 100, thereby reducing jitter caused by transitional delays.

It should also be appreciated that the decomposition 510 and recomposition 550 of virtual tours into video faces can be implemented at the single level described above, or as nested levels. For example, video face 210 may be further decomposed into two or more sub-faces (not shown). Accordingly, the anticipatory streaming of additional video face(s) may optionally be implemented at the sub-face(s) level.

In sum, the present invention provides systems and methods for efficiently decomposing, storing, recomposing and streaming of panoramic videos for virtual tours executing on mobile devices. The advantages of such systems and methods include lower bandwidth requirements, higher resolution for the same bandwidth, a superior virtual tour visitor experience, lower power consumption by the mobile devices, lower memory requirement for the mobile devices

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. An efficient computerized method for streaming and displaying a virtual tour decomposed into a plurality of video faces stored in a virtual tour host, the virtual tour configured for display on a mobile device coupled to the virtual tour host via a network, the method comprising:
launching a virtual tour viewer in a mobile device;
detecting a field of view of the mobile device and reporting the field of view to a virtual tour host configured to store a plurality of video faces decomposed from a virtual tour;
receiving a video stream of the virtual tour recomposed from a subset of the plurality of video faces from the virtual tour host, wherein the subset of the plurality of video faces corresponds to the detected field of view of the mobile device; and
displaying the video stream using the virtual tour viewer executing in the mobile device.

2. The method of claim 1 wherein the subset of the plurality of video faces includes at most two adjacent video faces selected from the plurality of video faces.

3. The method of claim 1 wherein the subset of the plurality of video faces includes at most three adjacent video faces selected from the plurality of video faces.

4. The method of claim 1 wherein the plurality of video faces forms a substantial cylinder.

5. The method of claim 1 wherein the plurality of video faces forms a substantial cube.

6. The method of claim 1 wherein the plurality of video faces forms a substantial sphere.

7. The method of claim 1 further comprising selecting and buffering an additional video face based on an anticipated movement of the mobile device.

8. An efficient computerized method for streaming and displaying a virtual tour decomposed into a plurality of video faces stored in a virtual tour host, the virtual tour configured for display on a mobile device coupled to the virtual tour host via a network, the method comprising:
decomposing a virtual tour into a plurality of video faces;
storing the plurality of video faces in a virtual tour host;
receiving a field of view of a mobile device;
recomposing a video stream of the virtual tour from a subset of the plurality of video faces, wherein the subset of the plurality of video faces corresponds to the field of view of the mobile device; and
sending the video stream of the virtual tour to the mobile device for display.

9. The method of claim 8 wherein the subset of the plurality of video faces includes at most two adjacent video faces selected from the plurality of video faces.

10. The method of claim 8 wherein the subset of the plurality of video faces includes at most three adjacent video faces selected from the plurality of video faces.

11. The method of claim 8 wherein the plurality of video faces forms a substantial cylinder.

12. The method of claim 8 wherein the plurality of video faces forms a substantial cube.

13. The method of claim 8 wherein the plurality of video faces forms a substantial sphere.

14. The method of claim 8 further comprising selecting and streaming an additional video face based on an anticipated movement of the mobile device.

15. A virtual tour host server configured to efficiently stream virtual tours for display on a mobile device coupled to the virtual tour host server via a network, the host server comprising:
memory configured to store a plurality of virtual tours;
a processor configured to:
decompose at least one of the plurality of virtual tours into a plurality of video faces for storage in the memory;
receive a field of view of a mobile device; and
recompose a video stream of the at least one virtual tour from a subset of the plurality of video faces, wherein the subset of the plurality of video faces corresponds to the field of view of the mobile device; and
an output port configured to send the video stream of the at least one virtual tour to the mobile device for display.

16. The host server of claim 15 wherein the subset of the plurality of video faces includes at most three adjacent video faces selected from the plurality of video faces.

17. The host server of claim 16 wherein the plurality of video faces forms a substantial cube.

18. The host server of claim 16 wherein the processor is further configured to select an additional video face based on an anticipated movement of the mobile device, and wherein the input-output port is further configured to stream the additional video face to the mobile device.
